(19) United States
(12) Patent Application Publication
(10) Pub. No.: US 2016/0141054 A1
(43) Pub. Date: May 19, 2016

(54) IN-VESSEL AND EX-VESSEL MELT COOLING SYSTEM AND METHOD HAVING THE CORE CATCHER

(71) Applicant: Korea Advanced Institute of Science and Technology, Daejeon (KR)

(72) Inventors: Hee Cheon No, Daejeon (KR); Byung Ha Park, Daejeon (KR)

(21) Appl. No.: 14/938,937

(22) Filed: Nov. 12, 2015

(30) Foreign Application Priority Data
Nov. 13, 2014 (KR) 10-2014-0158042

(51) Int. Cl. G21C 9/016; G21C 15/18

(52) U.S. Cl. CPC G21C 9/016; G21C 15/18

(57) ABSTRACT

The present invention relates to the in-vessel and ex-vessel melt cooling system having the core catcher. This system includes a reactor vessel having the core inside of the vessel, a core catcher that can cool the core melt ejecting from the damaged reactor vessel, a reactor cavity including the reactor vessel and the core catcher, IRWST (In-Containment Refueling Water Storage Tank) that can supply cooling water to the reactor cavity, and a control unit that can cut out the cooling water supply when the reactor cavity is filled with cooling water to the required level.

### BACKGROUND OF THE INVENTION

1. Field of the Invention

The present invention relates to a core melt cooling system, more precisely the in-vessel and ex-vessel melt cooling system and method having a core catcher.

2. Description of the Related Art

In general, a nuclear power plant is composed of more than 100 individual functional systems, which are largely divided into nuclear steam supply system including a nuclear reactor, a turbine that is running the generator with steam supplied from the said nuclear steam supply system, a generator system, and other appended facilities.

In particular, the nuclear reactor is a multi-task apparatus that can generate heat by controlling fission chain reaction of a fissile material, produce radio-isotope and plutonium, or form a radiation field. The pressurized water reactor uses water as a moderator and a coolant, which is largely divided into two types according to the structural characteristics; a loop type reactor and an integral type reactor.

The loop type reactor has a rector, a pressurizer, a steam generator, and a coolant pump separately located in a containment vessel, which are connected to one another through piping. The steam generator is connected with a steam turbine through piping. So, electricity is produced in a generator running by steam supplied from a steam generator.

In the meantime, the integral type reactor is installed in a nuclear reactor vessel along with a core and other major devices such as a pressurizer, a steam generator, and a coolant pump without piping. The coolant heated in the core flows through the coolant pump, during which the flow direction is changed downward, so that the coolant is supplied in the ring-shaped cavity in the upper part of the steam generator. The coolant is cooled down in the steam generator by heat-exchange and then circulated back to the core.

One of the biggest radiation leakage accidents in the nuclear power plant is LOCA (Loss of Coolant Accident) that is characterized by radiation leakage by damage of pressure boundary in the reactor coolant system.

When LOCA (Loss of Coolant Accident) happens in the conventional loop type pressurized water reactor, the coolant ejected from the reactor through broken pipes is supplemented in the reactor by using the emergency core cooling system that combines the active system composed of the high-pressure and low-pressure safety injection pump and the passive system including the N₂-pressurized safety injection tank.

In the early stage of LOCA (Loss of Coolant Accident), water flows from IRWST (In-Containment Refueling Water Storage Tank) to the reactor through the high-pressure and low-pressure injection pumps and the water in the safety injection tank is passively supplied to the reactor by the pressure. In the late stage of the accident, wherein the water in IRWST and the safety injection tank is all consumed, the water stored in sump in the containment vessel is supplied to the reactor through the high-pressure safety injection pump.

In the conventional reactor (OPR1000, etc), water is safely supplied through the high and low-pressure injection pumps not from IRWST but from RWST (Refueling Water Storage Tank) or BWST (Borated Water Storage Tank). In the meantime, RWST has been replaced with IRWST in the developing ARP1400 reactor.

This kind of coolant supplementation method has been successfully applied to a nuclear power plant in the case of pipe rupture depending on such active devices as pumps over the past decades, and the safety of this method has been verified. However, the operation of the active safety system including pumps and valves can increase the complexity in reactor operation and management and at the same time increases the construction expenses. A powerful driving power is also necessary in order to run the active pump, which might reduce economical efficiency of the nuclear power plant.

Therefore, it has been requested to develop a method to increase both the stability and the economic efficiency of the nuclear power plant. Recently, various safety systems introduced with various passive conceptions have been tried. The passive safety system is operated by using passive power such as gravity, natural circulation, and gas compressive force, etc, so that the simplicity, stability, and reliability of the power plant can be increased, compared with the active safety system of the conventional nuclear power plant.

Korean Patent Publication No. 10-2009-0021722 describes the airwater combined passive reactor cavity cooling system for eliminating remaining heat in the core which is composed of an air cooling apparatus that emit the air heated by the remaining heat from the reactor cavity by using the cold air flowed in from outside and a water cooling apparatus that can cool down the water heated by the remaining heat generated from the reactor cavity by circulating the heated water outwardly with ex-vessel heat-exchange.

Korean Patent Publication No. 10-2005-0080667 describes the core melt passive cooling and trapping apparatus to cool down and solidify the melt passively so as to trap the solidified melt in a containment vessel. When a critical accident happens in a nuclear power plant, the nuclear fuel in the core melts down and extremely high temperature melt emitting radiation ejected from the damaged nuclear reactor. Then, the surrounding structures are eroded and the safety of workers is in danger, in addition to the worry about soil or water contamination. This passive cooling and trapping apparatus, therefore, is designed to avoid such problems.

### SUMMARY OF THE INVENTION

It is an object of the present invention to provide an in-vessel and ex-vessel melt cooling system and method having a core catcher that can cool down in and out of the reactor cavity and reactor vessel in order to control the core melt ejected from the damaged reactor vessel.

It is another object of the present invention to provide an in-vessel and ex-vessel melt cooling system and method having the core catcher that can cool down the core melt and contains at least one of these pebble-type ceramic, glass material, and oxide.

It is also an object of the present invention to provide an in-vessel and ex-vessel melt cooling system and method having the core catcher wherein coolant is supplied to the reactor using IRWST for the newly developing nuclear power plant.

It is further an object of the present invention to provide an in-vessel and ex-vessel melt cooling system and method having the core catcher wherein coolant is supplied using RWST or sea water for the conventional nuclear power plant.

The in-vessel and ex-vessel melt cooling system having the core catcher of the present invention is composed of a reactor vessel having the reactor core therein, a core catcher that can cool down the core melt ejected from the damaged vessel, a reactor cavity harboring the reactor vessel and the said core catcher, IRWST (In-Containment Refueling Water Storage Tank) that can supply coolant to the reactor cavity, and a control unit that can shut out the coolant supply when the reactor cavity is filled with coolant to the required level, wherein the said reactor cavity is divided by partition wall into two parts; the upper part where the reactor vessel is equipped and the lower part where the core catcher and coolant are furnished.

The core catcher is composed characteristically of at least one of these pebble-type ceramic, glass material, and oxide.

The core catcher is transformed into vitreous material when it is combined with the said core melt.

The partition wall is penetrated by the core melt ejected from the damaged reactor vessel.

The reactor cavity is equipped with a water level sensor at a designated position of the upper part.

The lower part of the reactor cavity is linked to IRWST (In-Containment Refueling Water Storage Tank) by a pipe equipped with a valve.

The IRWST is characteristically positioned higher than the upper part of the reactor cavity.

The control unit gives the valve an order to open when the water level sensor cannot sense coolant and to close when the sensor detects coolant at the level.

The in-vessel and ex-vessel melt cooling method of the present invention is composed of the following steps: Core melt ejects when the reactor vessel is damaged; The ejected core melt penetrates the partition wall of the reactor cavity; The core melt penetrated through the partition wall is combined with the core catcher; The combined core melt is cooled down; and The reactor vessel is cooled down.

In the above method, the step of cooling the reactor vessel is characterized by cooling down both inside and outside of the reactor vessel by coolant.

According to this method, coolant flows in to the reactor vessel through the damaged region or crack of the reactor vessel to cool down the vessel for preventing the ejection of the secondary melt.

### ADVANTAGEOUS EFFECT

The in-vessel and ex-vessel melt cooling system and method having the core catcher of the present invention can cool down the reactor cavity and both inside and outside of the vessel fast when the core melt ejects from the damaged reactor vessel, so that the system and method can increase the stability of the vessel.

This system and method is also advantageous because of the core catcher equipped therein which is composed of at least one of these pebble-type ceramic, glass material, and oxide and is able to cool down the core melt so efficiently that it can prevent the explosion by the steam generated from coolant and the ejection of the core melt.

It is not necessary for the newly developing nuclear power plant to have an additional water tank when the system and method of the invention is applied thereto, since coolant can be supplied using IRWST according to the system of the invention.

It is not necessary for the conventional nuclear power plant to have an additional water tank when the system and method of the invention is applied thereto, since coolant can be supplied using RWST or sea water according to the system of the invention.

### BRIEF DESCRIPTION OF THE DRAWINGS

The application of the preferred embodiments of the present invention is best understood with reference to the accompanying drawings, wherein:

FIG. 1 is a schematic diagram illustrating the core melt cooling system according to an example of the present invention.

FIG. 2-FIG. 5 are schematic diagrams illustrating the emergency operation conditions of the core melt cooling system according to an example of the present invention.

FIG. 6 is a flow chart illustrating the core melt cooling method according to an example of the present invention.

### DESCRIPTION OF THE PREFERRED EMBODIMENTS

Hereinafter, the examples of the present invention are illustrated in detail with the attached figures. To give reference marks to the components of each figure, a same mark is given to the same components even if they are shown in different figures. In this description, if considered that a precise description on the related element or function is already well known to those in the art or may make it vaguer to understand, it would be omitted.

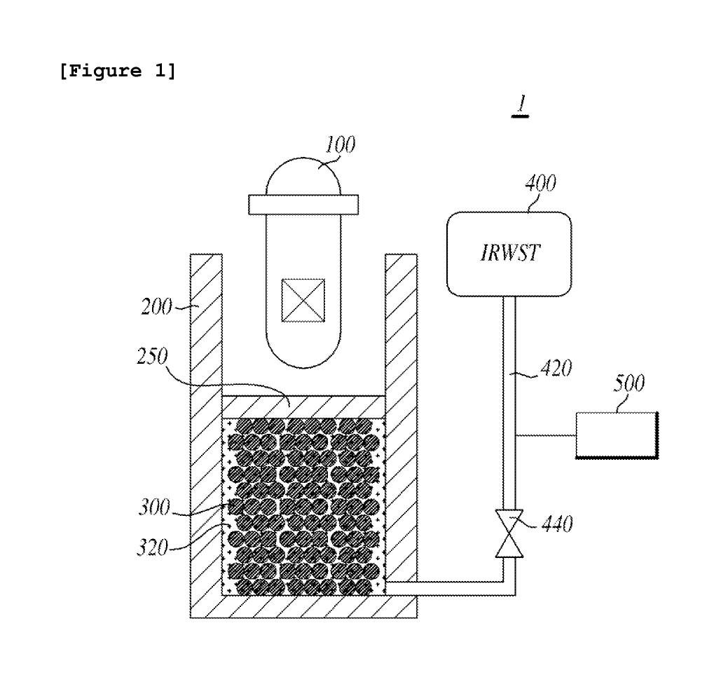

FIG. 1 is a schematic diagram illustrating the core melt cooling system according to an example of the present invention.

As shown in FIG. 1, the core melt cooling system (1) is to cool down the core melt ejecting from the damaged reactor vessel (100). The core melt cooling system (1) is able to cool down the core melt with the aid of the core catcher (300) and the coolant (320). The core melt cooling system (1) is for passive cooling, but the control of the coolant (320) is achieved actively.

The core melt cooling system (1) is composed of the reactor vessel (100), the reactor cavity (200), the core catcher (300), the in-containment refueling water storage tank (IRWST) (400), and the control unit (500).

The reactor vessel (100) is the vessel that surrounds the reactor core, which is composed of steel, aluminum, and prestressed concrete that can be suitable for the reactor core and reflector.

The reactor cavity (200) is the room that is made when the reactor vessel (100) is encircled. In this invention, the reactor cavity (200) includes the partition wall (250) that can divide the cavity into the upper part that surrounds the reactor vessel (100) and the lower part that surrounds the core catcher (300). In particular, the upper part of the reactor cavity (200) is equipped with a water level sensor (not presented) positioned at a designated position and the lower part is connected to a pipe through which coolant is supplied from IRWST (400).

The core catcher (300) comprises at least one of these pebble-type ceramic, glass material, and oxide. The core catcher (300) is combined with the core melt ejecting from the damaged reactor vessel (100), by which it turns into vitreous material so that it can prevent the ejection of the secondary core melt.

The IRWST (400) is the in-containment refueling water storage tank used in a nuclear power plant, which is to store coolant for emergency. The IRWST (400) is designed to filter out impurities of emergency coolant in the reactor by the equipped filter assembly. The IRWST (400), being connected to the reactor cavity (200), is also able to supply coolant (320) that can cool down the core melt ejecting from the damaged reactor vessel (100) in addition to the above basic function. In particular, the IRWST (400) is equipped higher than the upper part of the reactor cavity. The IRWST (400) is connected to the reactor cavity (200) by a pipe (420) equipped with a valve (440).

In this description, the composition of the core melt cooling system (1) for the coolant supply is not limited to IRWST (400). In the case of the core melt cooling system (1) that does not include IRWST (400), the core melt cooling system (1) can use RWST or sea water instead. That is, for example, the newly developing reactor APR1400 can use IRWST (400) for the coolant supply but the conventional nuclear power plant (OPR1400, etc.) can use RWST or sea water. Therefore, the core melt cooling system (1) does not require an additional water tank, so that the costs can be saved.

The control unit (500) is to open and close the valve (440). That is, the control unit can control the supply of coolant. Precisely, the control unit (500) maintains the valve opened under the normal condition, but gives an order to shut down when coolant (320) reaches the level that can be detected by the water level sensor.

In the core melt cooling system (1), the reactor cavity (200) is divided into two parts by the partition wall (250); the upper part having the reactor vessel (100) and the lower part having the core catcher (300) filled with the coolant (320) supplied from the IRWST (400).

That is, in the lower part of the reactor cavity separated by the partition wall, the core catcher is equipped. Coolant fills the pores of the pebble-type core catcher. So, when the core melt penetrates the partition wall and contacts with the core catcher, the leakage of the fission product can be prevented and also the explosion triggered by steam rapidly generated therein can be prevented.

At this time, the ratio of the core catcher (300) to the coolant (320) can be regulated by the condition of the core melt cooling system (1).

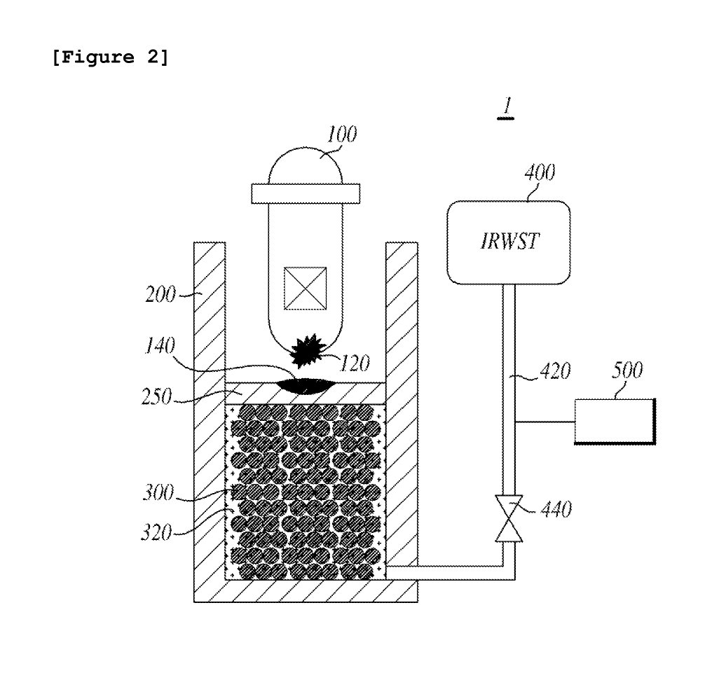

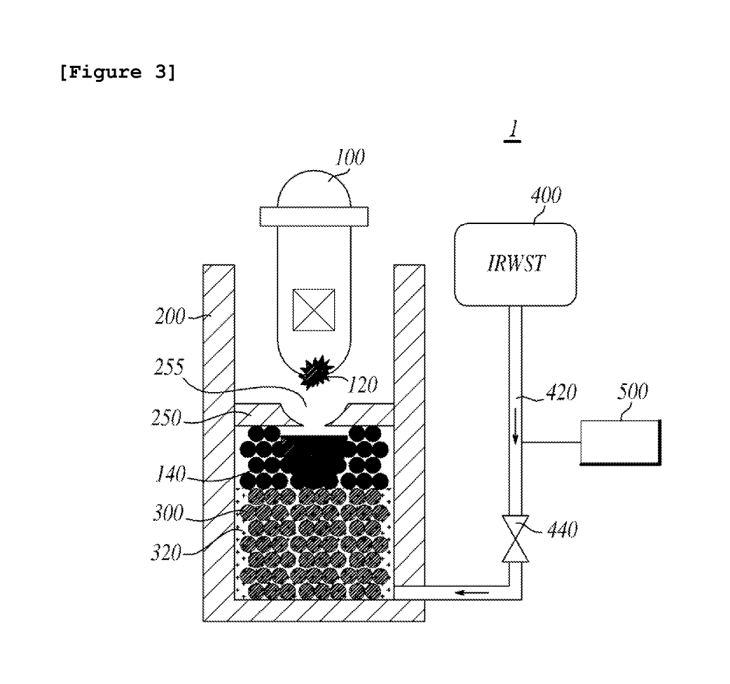

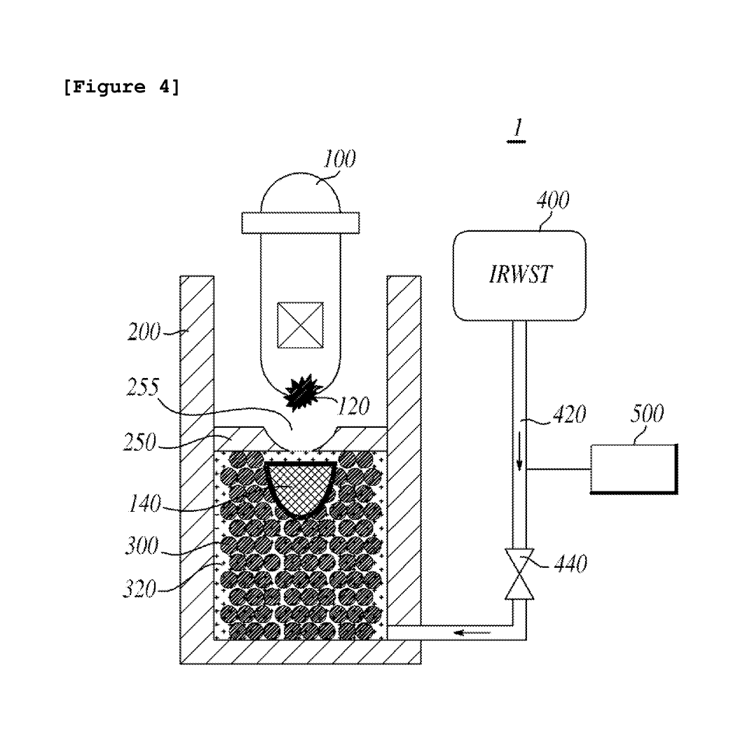

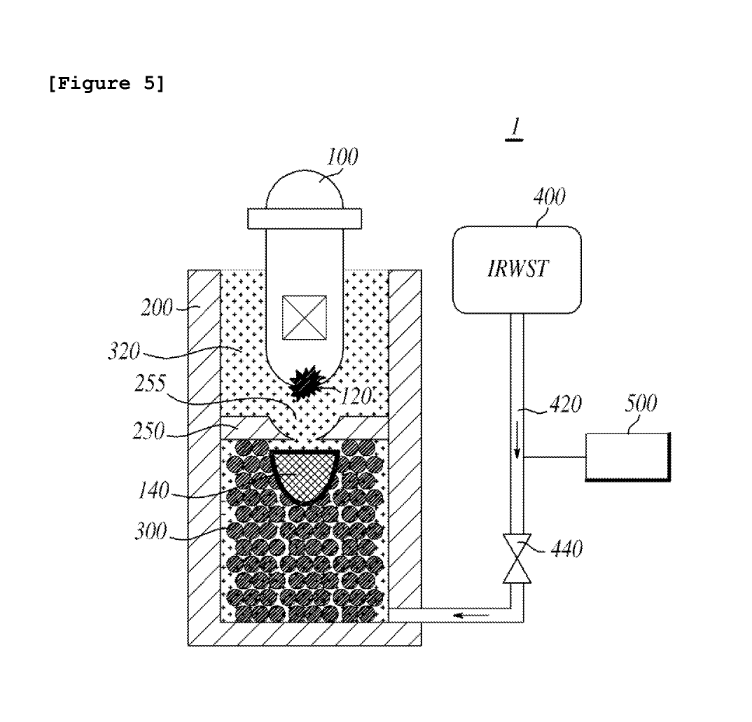

FIG. 2-FIG. 5 are schematic diagrams illustrating the emergency operation conditions of the core melt cooling system according to an example of the present invention.

As shown in FIG. 2-FIG. 5, the core melt cooling system (1) starts its action when the reactor vessel (1) is damaged and the core melt (140) ejects from it. That is, the core melt cooling system (1) remains as being filled with coolant (320) under the normal condition, but starts working when the reactor vessel (100) is damaged.

The said core melt (140) is a lava-like mixture made of melted core. In the core melt (140), nuclear fuels, fission products, and control rods are melted and mixed altogether. So, the core melt is a chemical mixture made by the reaction of such materials with air, water, and steam.

When the reactor vessel (100) is damaged, the core melt (140) trapped in the reactor vessel (100) ejects from the damaged part (120). The damaged part (120), as shown in FIG. 2, is not limited to the lower part of the reactor vessel (100) and can be any part of the reactor vessel (100).

The core melt (140) drops down on the partition wall (250) in the reactor cavity (200). Then, the partition wall (250) begins to melt and be penetrated, by which the upper part and the lower part of the reactor cavity are connected. At this time, the partition wall (250) has the effect of slowing down the ejection of the core melt (140). To obtain such an effect, the partition wall (250) is supposed to be 0.3 m˜1 m thick and more preferably 0.5 m thick.

The core melt cooling system (1) cools down the ejected core melt (140) with the core catcher (300) and the coolant (320). The core melt cooling system (1) solidifies the ejected core melt (140), so that the waste treatment becomes easy. Also, the core melt cooling system (1) prevents steam explosion accident.

The core melt (140) penetrates the partition wall (250) of the reactor cavity (200) through the penetrated hole (255) formed on the partition wall (250) and then moves down to the lower part of the reactor cavity (200). The core melt (140) contacts with the core catcher (300) and the coolant (320) in the lower part of the reactor cavity (200). Here, the core melt (140) is combined with the core catcher (300) to become vitreous material, by which the leakage of the fission product can be prevented. The core melt (140) is cooled down when it contacts with the coolant (320) and at the same time it generates steam. However, steam explosion accident can be prevented by the contact of the core melt (140) with the mixture of the core catcher (300) and the coolant (320).

That is, the contact surface between the core melt (140) and the coolant (320) is reduced by the core catcher (320), so that instant massive steam generation is inhibited, resulting in the prevention of steam explosion accident.

Herein, the ratio of the core catcher (300) to the coolant (320) can be adjusted according to the size and design environment of the core melt cooling system (1).

The core melt cooling system (1) provides coolant (320) when original coolant has been evaporated. The core melt cooling system (1) provides coolant (320) stored in IRWST (400) to the lower part of the reactor cavity (200) through the valve (420). At this time, the supply of coolant (320) is passive supply by gravity.

So, the core melt cooling system (1) preferably has the IRWST (400) positioned at a higher location than the reactor cavity (200).

The core melt (140) is cooled down by the combined action of the core catcher (300) and the coolant (320) in the lower part of the reactor cavity (200). When the core melt (140) is first ejected into the lower part of the reactor cavity (200), the coolant (320) in the lower part of the reactor cavity (200) is instantly evaporated at first, but as time passes the lower part is being flooded by coolant (320) supplied from the IRWST (400).

That is, the coolant (320) that is evaporated by the core melt (140) is less than the coolant (320) that is supplied from the IRWST (400).

According to the core melt cooling system (1) of the present invention, coolant (320) flows through the penetrated hole (255) formed on the partition wall (250) to cool down the upper part of the reactor cavity (200) and both inside and outside of the reactor vessel (100). This core melt cooling system (1) contributes to the improvement of stability because it is usable to cool down the inside and outside of the reactor vessel (100) heated by the core melt (140).

The core melt cooling system (1) has the water level sensor equipped in the upper part of the reactor cavity (200) which is to regulate the level of coolant. It is also possible with this core melt cooling system (1) to control the level of coolant by using gravity by adjusting the position of the IRWST (400).

The reactor vessel (100) is cooled down by the coolant (320) flowing in through the penetrated hole (255). More precisely, coolant flows in through the damaged part (120) of the reactor vessel (100), by which the lower part of the reactor vessel (100) can be cooled down. As the level of coolant (320) rises, the outside of the reactor vessel (100) can also be cooled down.

Herein, the upper part of the reactor cavity (200) has the water level sensor at a required location and when coolant meets the level, it is shut off. This shut off is achieved by the closure of the valve (440) according to the order of the control unit (500).

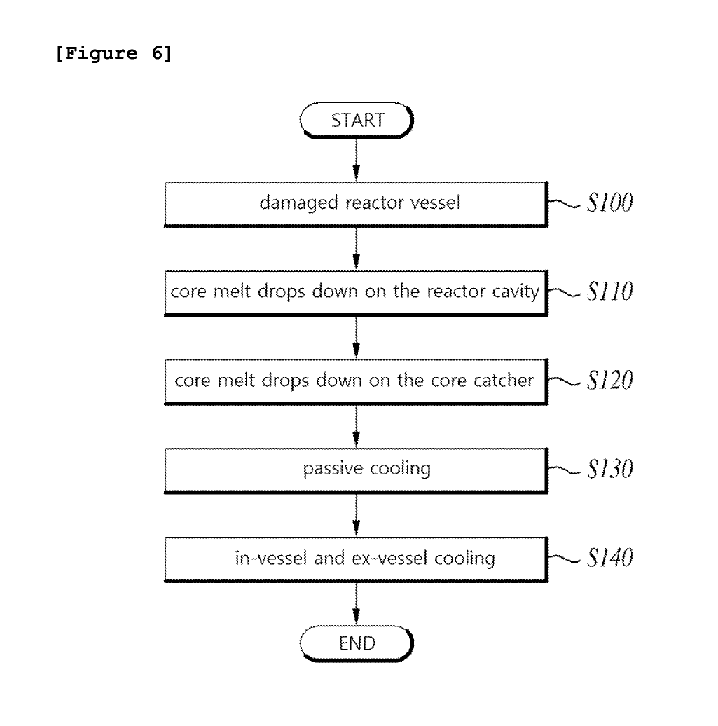

FIG. 6 is a flow chart illustrating the core melt cooling method according to an example of the present invention.

As shown in FIG. 6, the method for cooling the core melt of the present invention comprises the step of cooling the core melt (140) ejected from the damaged reactor vessel (100) with the core catcher (300) and coolant (320). This core melt cooling is passive cooling but the control of coolant (320) is actively achieved.

The core melt cooling method can be performed by the following steps.

Step 1: The reactor vessel (100) is damaged, from which the core melt (140) ejects.

Precisely in step 1, the reactor vessel (100) is damaged by the high temperature core melt (140) deposited in the reactor vessel (100). At this time, the temperature of the core melt (140) is 2800° C. 3200° C. The reactor vessel (100) can resist the temperature up to around 1200° C.

That is, the reactor vessel (100) cannot endure such a high temperature of core melt (140), and then become damaged.

Step 2: The ejected core melt passes through the partition wall (250) of the reactor cavity (200).

Precisely in step 2, the core melt (140) ejected from the damaged vessel in step 1 drops down in the reactor cavity (200). More precisely, the core melt can pass through the partition wall (250) of the reactor cavity (200) because the partition wall (250) melts down by such a high temperature of the core melt (140), by which the upper part and the lower part of the reactor cavity combines as one room.

Step 3: The core melt (140) penetrated through the partition wall (250) is combined with the core catcher (300).

Precisely in step 3, the core melt (140) penetrated through the partition wall (250) is combined with the core catcher (300), resulting in cooling. The core melt (140) is cooled down not just by being combined with the core catcher (300) but also by coolant (320). At this time, when the core melt (140) is contacted with coolant (320), steam is generated. However, since the contact surface is reduced because of the core catcher (300), the amount of the generated steam is not so huge.

In step 3, the core melt (140) which has been combined with the core catcher (300) turns into vitreous material, by which the flow of the core melt (140) is limited.

Step 4: The combined core melt (140) is cooled down.

Precisely in step 4, the core melt (140) is cooled down by the coolant (320) supplied from IRWST (400). In this step, the coolant (320) is provided from IRWST (400) as much as the coolant that has been evaporated in step 3. The method for the coolant supply herein is a passive one achieved by gravity. In this step, the core melt (140) becomes solidified, which also makes the waste treatment easy.

Step 5: The reactor vessel (100) is cooled down.

Precisely in step 5, the coolant (320) flows in through the penetrated hole (255) formed in step 2 in order to cool down the reactor vessel (100). In particular, coolant (320) flows in through the damaged area (120) of the reactor vessel (100) to cool down both inside and outside of the reactor vessel (100).

At this time, when the coolant (320) is sensed by the water level sensor equipped on the reactor cavity (320), the valve (440) is shut off by the order of the control unit (500), so that the coolant (320) is no more supplied.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended Claims.

### BRIEF DESCRIPTION OF THE MARK OF DRAWINGS

1: core melt cooling system

100: reactor vessel

120: damaged area

140: core melt

200: reactor cavity

250: partition wall

255: penetrated hole

300: core catcher

320: coolant

400: IRWST

420: pipe

440: valve

500: control unit

What is claimed is:

1. An in-vessel and ex-vessel melt cooling system having the core catcher comprising the following parts:
the reactor vessel having the reactor core therein;
the core catcher that can cool down the core melt ejecting from the damaged vessel;
the reactor cavity harboring the reactor vessel and the core catcher;
the in-containment refueling water storage tank (IRWST) that can supply coolant to the reactor cavity; and
the control unit that can shut out the coolant supply when the reactor cavity is filled with coolant to the required level, wherein the said reactor cavity is divided by partition wall into two parts; the upper part where the reactor vessel is equipped and the lower part where the core catcher and coolant are furnished.

2. The in-vessel and ex-vessel melt cooling system having the core catcher according to claim 1, wherein the core catcher includes at least one of these materials selected from the group consisting of pebble-type ceramic, glass material, and oxide.

3. The in-vessel and ex-vessel melt cooling system having the core catcher according to claim 1, wherein the core catcher is characteristically changed into vitreous material when it is combined with the core melt.

5. The in-vessel and ex-vessel melt cooling system having the core catcher according to claim 1, wherein the partition wall is penetrated by the core melt ejected from the damaged reactor vessel.

6. The in-vessel and ex-vessel melt cooling system having the core catcher according to claim 4, wherein the reactor cavity is equipped with a water level sensor at a designated position of the upper part.

7. The in-vessel and ex-vessel melt cooling system having the core catcher according to claim 4, wherein the lower part of the reactor cavity is connected to the IRWST by pipes, and at this time the pipes are equipped with valves.

8. The in-vessel and ex-vessel melt cooling system having the core catcher according to claim 1, wherein the IRWST is located higher than the upper part of the reactor cavity.

9. The in-vessel and ex-vessel melt cooling system having the core catcher according to claim 6, wherein the control unit controls the opening and the closure of valves, precisely in order to open valves when the water level sensor does not recognize coolant and to shut off valves when the sensor recognized coolant at the level.

10. An in-vessel and ex-vessel melt cooling method using the cooling system of claim 1, which comprises the following steps:
Core melt ejects when the reactor vessel is damaged;
The ejected core melt penetrates the partition wall of the reactor cavity;
The core melt penetrated through the partition wall is combined with the core catcher;
The combined core melt is cooled down; and
The reactor vessel is cooled down.

11. The in-vessel and ex-vessel melt cooling method according to claim 10, wherein the step of cooling the reactor vessel is characterized by cooling down both inside and outside of the reactor vessel with the coolant.

12. The in-vessel and ex-vessel melt cooling method according to claim 11, wherein the coolant flows into the reactor vessel through the damaged area of the reactor vessel to cool down the vessel.
